(19) United States
(12) Patent Application Publication
(10) Pub. No.: US 2022/0309112 A1
(43) Pub. Date: Sep. 29, 2022

(54) BUILDING A BASE INDEX FOR SEARCH

(71) Applicant: Microsoft Technology Licensing, LLC, Redmond, CA (US)

(72) Inventors: Qi QU, Sunnyvale, CA (US); Zhenjiang LI, San Jose, CA (US); Hongbin WU, Redmond, WA (US); Erik Tao KROGEN, San Francisco, CA (US)

(21) Appl. No.: 17/211,042

(22) Filed: Mar. 24, 2021

(51) Int. Cl. G06F 16/951; G06F 16/27

(52) U.S. Cl. CPC G06F 16/951; G06F 16/278

(57) ABSTRACT

Embodiments of the disclosed technologies are capable of calculating a boundary value N as a function of a parameter M; for each of M first-level partitions of a set of data records, building an index for use by a downstream application by (i) building N second-level partitions using the key; indexing the N second-level partitions to produce N micro-shards; determining a value of a number of tiers parameter, T, and, for each tier, a value of a partitions per merge parameter P_{MT}, merging the N micro-shards using T tiers and, for each tier, P_{MT} partitions per merge, distributed across a plurality of host machines; where M, N, T, and P_{MT} are each a positive integer and a value of M is determined based on the downstream application.

### TECHNICAL FIELD

A technical field to which the present disclosure relates is search engine indexing systems.

### BACKGROUND

A distributed data processing system provides a software framework for distributed storage and processing of data on a large scale. A distributed software framework may store portions of data files across many different computers on a network. The distributed data processing system coordinates data storage operations and computations across the network of computers. In some distributed data processing systems, data storage and processing is disk-based. Disk-based systems are designed to handle batch processing efficiently but with high latency. Other distributed data processing systems perform computations in-memory (e.g., random access memory as opposed to disk) which allows them to handle real-time data processing efficiently with low latency.

In-memory and disk-based distributed data processing systems can be used together. For example, data may be stored using a disk-based system while an in-memory system may be used on top of the disk-based system for computations that need fast turnaround.

Indexes are used to quickly locate data in a database. For example, indexes allow data to be located within a database without conducting a full table scan in which every row in a database table is searched every time the database table is accessed. Much like the index of a book identifies the pages on which particular words are printed, an index in the database context identifies the particular logical or physical storage locations of particular data items stored in the database.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating at least one embodiment of a computing system in which aspects of the present disclosure may be implemented.

FIG. 2 is a flow diagram of a process that may be used to implement a portion of the computing system of FIG. 1.

FIG. 3 is a flow diagram of a process that may be used to implement a portion of the computing system of FIG. 1.

FIG. 4A is a flow diagram of a process that may be used to implement a portion of the computing system of FIG. 1

FIG. 4B is a plot of experimental results achieved by an embodiment of a portion of the computing system of FIG. 1.

FIG. 5 is a flow diagram of a process that may be used to implement a portion of the computing system of FIG. 1.

FIG. 6 is a block diagram illustrating an embodiment of a hardware system, which may be used to implement various aspects of the computing system of FIG. 1.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Network-based software applications often store and process massive amounts of data. For example, connections network systems, such as social media applications and applications based thereon, may store millions or even billions of searchable data records. An example of a data record is a row of a database table. The data stored in the particular row is linked to a particular value of a unique identifier (ID); thus, the unique ID can be used to retrieve the data records.

Network-based software applications often provide search functionality that allows users to search for and retrieve data records that match the users' search criteria by entering search queries. An example of a search criterion is a keyword, such as an entity name, job title or skill. To improve the efficiency of retrieving data from a database in response to users' search queries, a database design may be used that divides data across multiple different but related tables, where each of the related tables is linked with the others using a unique ID as a key. To enable fast retrieval of data records from a database that has divided data across multiple tables, indexes may be built on one or more columns of one or more of the database tables.

To build the indexes, data records are divided into partitions, e.g., different database rows are assigned to different partitions, and then indexes are built on the partitions. As used herein, a partition that has been indexed may be referred to as an indexed partition or simply as an index. The number of partitions that are created and indexed is specified based on the particular downstream application that uses the indexes. For example, a people search application may specify a number of partitions in the range of about 30 to about 35 partitions while a name search application may specify a number of partitions in the range of about 15 to about 20 partitions. After the specified number of partitions have been created and indexed for a particular downstream application, the resulting set of indexed partitions may be referred to as a base index.

A typical index build process performed using a disk-based distributed file system includes four steps: combine, divide, index and merge. Performing the index build using in-memory processing involves similar steps but has been shown to improve the indexing speed significantly. However, in experiments, the improvements in indexing speed were negated by performance issues in other parts of the in-memory index build process, such that the overall end-to-end build latency did not improve significantly. This latency issue was found to be due to bottlenecks in the combine and merge steps.

One such bottleneck is a technical problem known as data skew. In general, it is desirable for data to be uniformly distributed across the partitions that are used to create an index, a characteristic that may be referred to as parallelism. This is because increasing the amount of data in a partition generally increases the amount of time it takes to index the partition. Data skew happens when some partitions that are used to create an index have significantly more data in them than other partitions. If a partitioning process results in a large number of empty partitions and a small number of partitions that contain a lot of data, for example, then indexing the partitions is not effective to improve efficiency of the index build process. Thus, data skew can significantly detract from efficiencies that otherwise would be gained through partitioning.

Another type of bottleneck is a technical problem in distributed execution environments known as the straggler problem. The straggler problem occurs when a machine that is responsible for performing at least part of a computational step, such as the merging step, is completing the computations much more slowly than other machines performing other portions of the step. The slow performance of a machine may be due to, for example, high CPU (central processing unit) load, low memory, a throttled disk, a network I/O (input/output) bottleneck, and/or other performance issues with the machine or the execution environment. When one part of the merging process takes much longer to complete than the other parts of the merging process, completion of the entire merging process may be significantly delayed.

As described in more detail below, the disclosed technologies improve upon prior approaches by resolving these and/or other performance issues with in-memory index build processes. For example, embodiments of the disclosed technologies calculate different parameters than the prior approaches and use those parameters to perform the combine and divide steps of the index building process so as to avoid or reduce the risk of data skew issues. Additionally, embodiments of the disclosed technologies use a different methodology than prior approaches for performing the merge step of the index building process so as to avoid or reduce the risk of the straggler problem.

Experimental results have shown that the disclosed technologies are capable of building base indexes for search applications much faster than prior approaches. The disclosed technologies thereby fully enable in-memory processing to be used to build base indexes for search applications.

Example Use Case

The disclosed technologies may be described with reference to the example use case of indexing of entity profile records for search in the context of a network application, such as a social media application. Entity profile records use entity ID as a key. Examples of entity data that may be associated with a given entity ID include entity name, title, location, employer name, job title, and skills. In the database, entity data may be divided across multiple different tables, such as a person table, a company table, a jobs table, a skills table, and a connections table, where each of the various tables have entity ID as a key. Examples of entity IDs include user IDs and account IDs. As used herein, the term entity may refer to a person, such as a user of a network application, an organization, such as a company or other form of business entity, a job posting, or a news feed item.

Other Use Cases

The disclosed technologies are not limited to indexing entity profile records or social media applications but can be used to build indexes for database searching more generally. Also, the disclosed technologies are not limited to relational databases but are agnostic as to the underlying database structure. Further, the disclosed technologies may be used by many different types of network applications in which in-memory indexing of data records may improve performance, such as any application in which data records may be frequently searched and frequently updated.

Example Computing System

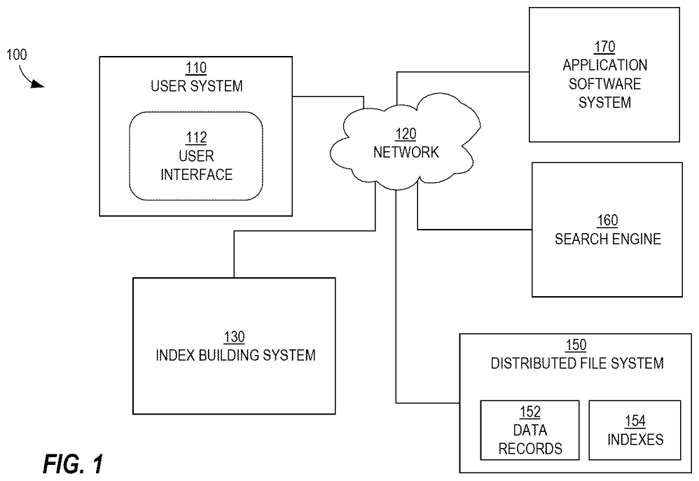

FIG. 1 illustrates a computing system in which embodiments of the features described in this document can be implemented. In the embodiment of FIG. 1, computing system 100 includes a user system 110, an index building system 130, a distributed file system 150, a search engine 160, and an application software system 170.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 may be or include a front-end portion of application software system 170.

User interface 112 is any type of user interface as described above. User interface 112 may be used to input search queries and view or otherwise perceive output retrieved by search engine 160 and/or produced by application software system 170. For example, user interface 112 may include a graphical user interface or a conversational voice/speech interface that includes a mechanism for entering and viewing a search query and search results, such as user profiles and/or other digital content.

Index building system 130 is configured to build and/or re-build base indexes using the approaches described herein. Example implementations of the functions and components of index building system 130 are shown in the drawings that follow and are described in more detail below. Portions of index building system 130 may be part of or accessed by or through another system, such as search engine 160 or application software system 170.

Distributed file system 150 includes at least one digital data store, such as a searchable database that includes a number of tables, which stores data records 152 and indexes 154. Portions of distributed file system 150 may be implemented using a combination of disk-based processing and in-memory processing, for example. An example of an index used for search is a LUCENE index.

Data records 152 and/or indexes 154 of distributed file system 150 may reside on at least one persistent and/or volatile storage device that may reside within the same local network as at least one other device of computing system 100 and/or in a network that is remote relative to at least one other device of computing system 100. Thus, although depicted as being included in computing system 100, portions of distributed file system 150 may be part of computing system 100 or accessed by computing system 100 over a network, such as network 120.

Search engine 160 interprets and executes search queries, which may be received via user interface 112, and retrieves data records 152 from distributed file system 150 using indexes 154, in response to search queries. Portions of search engine 160 may be part of or accessed by or through another system, such as application software system 170.

Application software system 170 is any type of application software system that includes or utilizes functionality provided by search engine 160. Examples of application software system 170 include but are not limited to connections network software, such as social media platforms, and systems that may or may not be based on connections network software, such as general-purpose search engines, job search software, recruiter search software, sales assistance software, advertising software, learning and education software, or any combination of any of the foregoing.

While not specifically shown, it should be understood that any of distributed file system 150, search engine 160 and application software system 170 includes an interface embodied as computer programming code stored in computer memory that when executed causes a computing device to enable bidirectional communication between application software system 170, search engine 160, or distributed file system 150 and index building system 130 using a communicative coupling mechanism. Examples of communicative coupling mechanisms include network interfaces, inter-process communication (IPC) interfaces and application program interfaces (APIs).

A client portion of application software system 170 may operate in user system 110, for example as a plugin or widget in a graphical user interface of a software application or as a web browser executing user interface 112. In an embodiment, a web browser may transmit an HTTP request over a network (e.g., the Internet) in response to user input that is received through a user interface provided by the web application and displayed through the web browser. A server running search engine 160 and/or a server portion of application software system 170 may receive the input, perform at least one operation using the input, and return output using an HTTP response that the web browser receives and processes.

Each of user system 110, index building system 130, distributed file system 150, search engine 160 and application software system 170 is implemented using at least one computing device that is communicatively coupled to electronic communications network 120. Index building system 130 may be bidirectionally communicatively coupled to distributed file system 150 and/or search engine 160 and/or application software system 170 by network 120. User system 100 as well as one or more different user systems (not shown) may be bidirectionally communicatively coupled to application software system 170.

A typical user of user system 110 may be an end user of application software system 170 or an administrator of application software system 170. User system 110 is configured to communicate bidirectionally with at least application software system 170, for example over network 120.

The features and functionality of user system 110, index building system 130, distributed file system 150, search engine 160, and application software system 170 are implemented using computer software, hardware, or software and hardware, and may include combinations of automated functionality, data structures, and digital data, which are represented schematically in the figures. User system 110, index building system 130, distributed file system 150, search engine 160, and application software system 170 are shown as separate elements in FIG. 1 for ease of discussion but the illustration is not meant to imply that separation of these elements is required. The illustrated systems and data stores (or their functionality) may be divided over any number of physical systems, including a single physical computer system, and can communicate with each other in any appropriate manner.

Network 120 may be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

It should be understood that computing system 100 is just one example of an implementation of the technologies disclosed herein. While the description may refer to FIG. 1 or to “system 100” for ease of discussion, other suitable configurations of hardware and software components may be used to implement the disclosed technologies. Likewise, the particular embodiments shown in the subsequent drawings and described below are provided only as examples, and this disclosure is not limited to these exemplary embodiments.

Example Index Building System

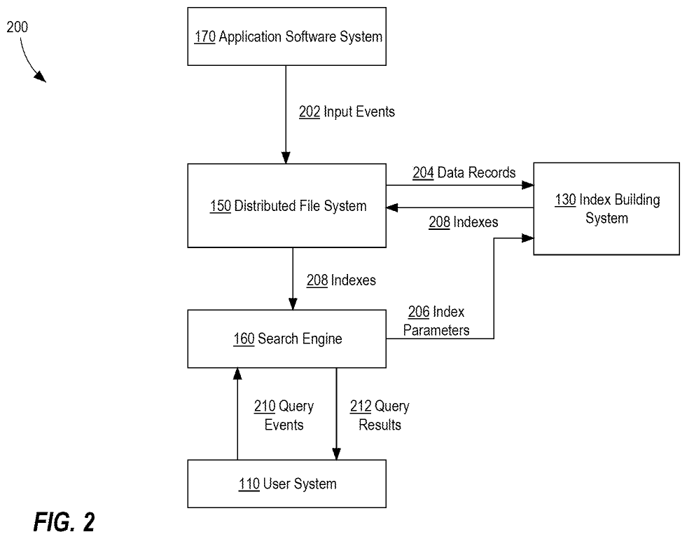

FIG. 2 is a simplified flow diagram of an embodiment of operations and components of a computing system capable of performing aspects of the disclosed technologies. The operations of a flow 200 as shown in FIG. 2 can be implemented using processor-executable instructions that are stored in computer memory. For purposes of providing a clear example, the operations of FIG. 2 are described as performed by computing system 100, but other embodiments may use other systems, devices, or implemented techniques.

In FIG. 2, index building system 130, search engine 160, and application software system 170 are each in bidirectional communication with distributed file system 150. Periodically and at any time, data records 204 are created, stored and updated in distributed file system 150 as a result of input events 202. Input events 202 are received by distributed file system 150 from application software system 170. For example, many different input events 202 may be generated by application software system 170 in response to activities of many different users of application software system 170. Examples of input events 202 include creation of an entity profile data record, adding data to or deleting data from an entity profile, creating a new connection between two entity profiles, and creating like, comment, or share events associated with an entity profile.

Index building system 130 receives data records 204 from distributed file system 150 and builds indexes 208 for data records 204. Indexes 208 are stored in distributed file system 150. Any given index that is built by index building system 130 may be built according to the requirements of a particular type of search. As such, index building system 130 receives index parameters 206 from search engine 160. An example of an index parameter is a number of partition indexes required by search engine 160 for a particular type of search. Examples of specific operations that may be performed by index building system 130 to create indexes 208 are shown in the drawings that follow, described below.

Periodically and at any time, search engine 160 receives query events 210 from a user system 110. For example, many different query events 210 may be received by search engine 160 from many different user systems 110 over, e.g., network 120, in response to search activities of many different users of application software system 170. Examples of query events 210 include people searches and entity name searches, such as searches on particular company names, job titles, or skills. Search engine 160 loads indexes 208 into memory and uses indexes 208 to serve the queries, e.g., locate data records 204 that are responsive to query events 210. Search engine 160 provides query results 212 to user system 110. Query results 212 include data records that have been retrieved using indexes 208 based on query events 210.

Example Index Building Process

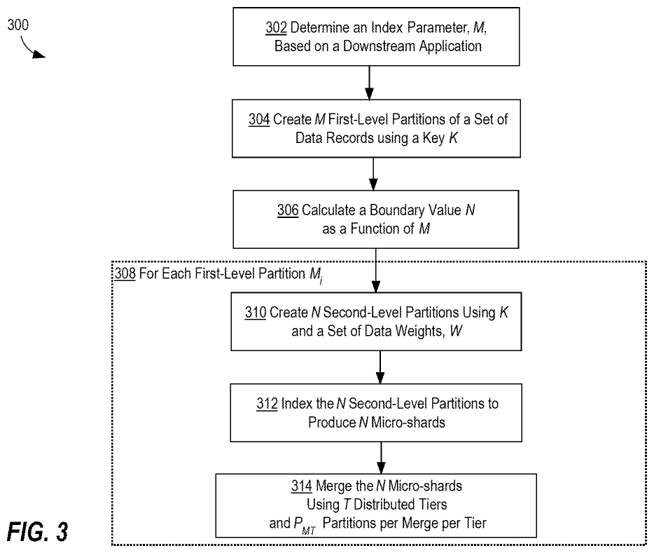

FIG. 3 is a simplified flow diagram of an embodiment of operations that can be performed by at least one device of a computing system. The operations of a flow 300 as shown in FIG. 3 can be implemented using processor-executable instructions that are stored in computer memory. For purposes of providing a clear example, the operations of FIG. 3 are described as performed by computing system 100, but other embodiments may use other systems, devices, or implemented techniques.

Operation 302 when executed by at least one processor causes one or more computing devices to determine a value of a number of partitions parameter, M, based on a downstream application. An example of a downstream application is a search engine, or more specifically, a particular type of search engine that has been configured to perform a particular type of search, such as a particular type of keyword search, on a set of data records. Examples of particular types of searches include name searches and people searches. The value of M may be passed to operation 302 by a search engine, for example as an index parameter 206.

Operation 304 when executed by at least one processor causes one or more computing devices to create M first-level partitions of a set of data records using a key. Where M is determined based on the requirements of a particular search application, the M first-level partitions are the index partitions used by that particular search application. To create the M first-level partitions, operation 304 may input the key into a MOD function or a CRC32MOD function, for example. Examples of keys are unique record identifiers such as entity ID or user ID.

In some embodiments, operation 304 may be performed by index building system 130 but in other embodiments, index building system 130 may receive the M first-level partitions from, for example, distributed file system 150. In embodiments where index building system 130 receives pre-partitioned data, operation 304 already has been performed by another system and may be omitted from index building system 130.

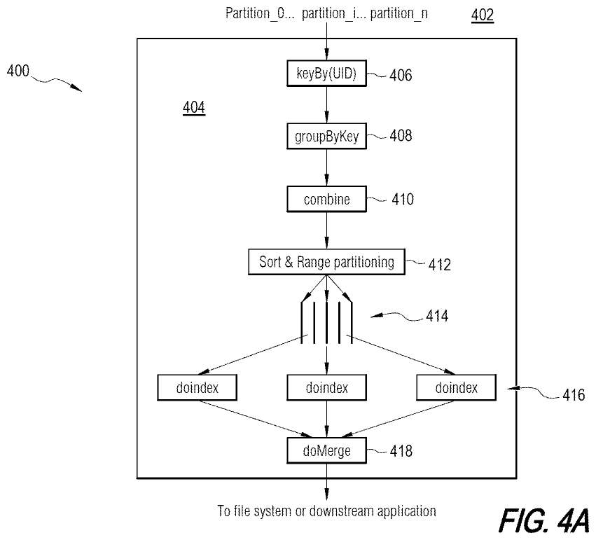

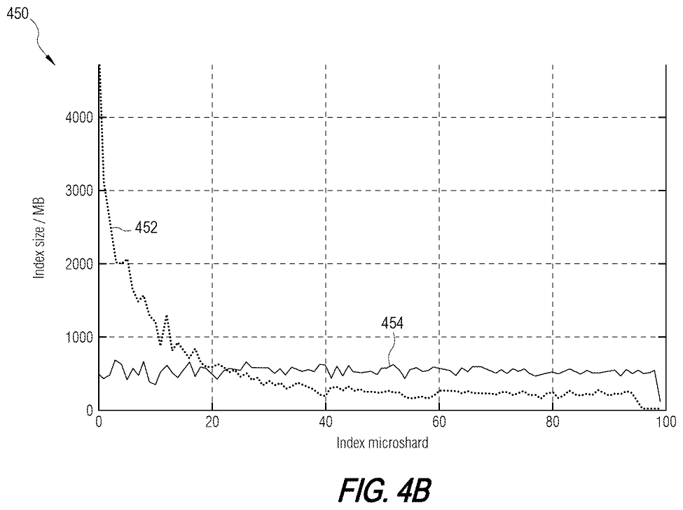

Data records within each of the M first-level partitions may be sorted according to one or more key values. A specific example of a manner in which the data records within each of the M first-level partitions may be sorted is described below with reference to FIG. 4A.

Operation 306 when executed by at least one processor causes one or more computing devices to calculate a boundary value N as a function of M. The boundary value N determines the number of second-level partitions to be created for each of the M first-level partitions. The value of N may be different for different search applications. The value of N is selected to maintain a balance between parallelism and scheduling overhead that may result from creating the N partitions in parallel. A specific example of a method for calculating N is described below with reference to FIG. 4A.

Operation 308 when executed by at least one processor causes one or more computing devices to perform a series of sub-operations 310, 312, 314, for each of the M first-level partitions using the boundary value N, in order to build a base index for use by the downstream application. Operations performed for each of the M first-level partitions may be performed in parallel and may be distributed across multiple machines.

Sub-operation 310 when executed by at least one processor causes one or more computing devices to create N second-level partitions using the key and a set of weight values. Thus, sub-operation 310 uses the same key to build the N second-level partitions as was used by operation 304 to create the M first-level partitions. Normally, using the same key to create both the first level and the second level of partitions would introduce data skew. However, the manner in which N is determined helps the system avoid data skew problems.

Additionally, a set of weight values, W, is used to sort the data records in each of the M first-level partitions. Each of the weight values in the set W is calculated as a function of a size of a data record, where the size quantifies the amount of data in the data record in, e.g., bytes. More specifically, each weight value in W corresponds to a size of a data record in the M first-level partition that is being sub-partitioned into the N second-level partitions. In an embodiment, sub-operation 310 uses the parameter value N and the weight values W to perform composite partitioning on each of the M first-level partitions. Thus, the output of sub-operation 310 is, for each of the M first-level partitions, N second-level partitions. A specific example of a method of performing the composite partitioning is described below with reference to FIG. 4A.

Sub-operation 312 when executed by at least one processor causes one or more computing devices to index the N second-level partitions. To do this, sub-operation 312 may utilize an indexing function provided by distributed file system 150, which may be accessed by sub-operation 312 through an API, for example. An example of an indexing function is the doIndex method, which may be written using a scripting language such as PHP. As a result of indexing the N second-level partitions, sub-operation 312 produces N indexes for the second-level partitions, which may be referred to as index micro-shards.

Sub-operation 314 when executed by at least one processor causes one or more computing devices to merge the N index micro-shards using T tiers and, for each tier, P_{MT} partitions per merge, distributed across a plurality of host machines. To do this, sub-operation 314 determines a value of T, where T is a number of tiers parameter, and a value of P_{MT}, where P_{MT} is a partitions per merge parameter. Specific examples of methods for determining values of T and P_{MT} are described below with reference to FIG. 4A. In flow 300, the values of M, N, T, and P_{MT} are each a positive integer. The result of sub-operation 314 merging the N index micro-shards for each of the M first-level partitions is a set of M indexes corresponding to the M first-level partitions. Thus, at the conclusion of operation 308 for all of the M first-level partitions, flow 300 outputs M indexes, which may be referred to as a base index. The M indexed first-level partitions are made available for use by the downstream application.

Example Partitioning Process

FIG. 4A is a flow diagram of a process that may be used to implement a portion of the computing system of FIG. 1. More specifically, flow 400 is an example of a process that may be used to partition and index a set of data records.

In flow 400, input data 402 includes a set of pre-partitioned data records; that is, partitions 0, i, . . . , n, where n is a positive integer that corresponds to M, and M is determined based on a downstream application as described above. In other words, input data 402 includes data records partitioned into M first-level partitions, where the first-level partitions have been created using any standard technique, e.g., MOD or CRC32MOD partitioning. Within each of the M first-level partitions, data records are sorted in descending order by a rank, e.g., static rank, and in ascending order by the key, e.g., UID. A static rank is, for example, an indicator of activity in the application software system 170, such that data records having higher static rank are typically associated with users that are more active on the platform.

Operation 406 when executed by at least one processor causes one or more computing devices to create a key for each first-level partition that will be used to group data in the set of pre-partitioned data records by key value. In the example of FIG. 4, user ID (UID) is used as the key, but the key could be any unique identifier. Operation 406 may be performed using a database management API, for example.

Operation 408 when executed by at least one processor causes one or more computing devices to group the pre-partitioned data records according to the key created in operation 406. Thus, for example, in cases where an underlying database may store data across many different but related tables, operation 408 queries the database and groups the results together for each value of the key. Operation 408 may be performed using a database query language, such as structured query language (SQL).

Operation 410 when executed by at least one processor causes one or more computing devices to produce a single data record for each value of the key by combining the grouped-by-key-value data produced by operation 408 using, for example, a concatenation function. In order to perform the concatenation efficiently and avoid data skew, operation 410 creates a set of sub-partitions of each first-level partition. To do this, operation 410 performs hash partitioning using the key, e.g., UID, as an input to the hash partitioning function.

To avoid the data skew problem, operation 410 computes the value N, which determines the number of sub-partitions to be created by the hash partitioning, e.g., second-level partitions, for each first-level partition, using a method that maximizes the probability that parallelism will be achieved. In the embodiment of FIG. 4, operation 410 calculates N as a co-prime of M.

Mathematically, the value of N may be derived as follows:

Where M is the number of first-level partitions and N is the number of second-level partitions, the least common multiple of M and N is LCM (M, N). LCM (M, N) divided by M is the number of possible hash values that may be generated by hash partitioning. Thus, the proportion of parallelism that can be achieved given M and N is P=LCM (M, N) divided by (M*N). Since P has an upper bound of 1, P is maximized if and only if LCM (M, N)==M*N, thus M co-prime N.

After the combine steps of operation 410, a single data record containing all of the data for a particular key value is in one of the M first-level partitions, and the first-level partition for that particular key value has N second-level partitions. The same process is performed for each key value. Thus, operation 410 produces, for each key value, a combined record within one first-level partition.

The output of operation 410 is the input to operation 412. Operation 412 when executed by at least one processor causes one or more computing devices to sort the combined data records produced by operation 410 by a sort criterion that includes a weight W that is an indicator of data record size (e.g., data size in bytes). The sort criterion may also include a rank; e.g., static rank and key. For example, operation 412 may sort the data records in the N second-level partitions in descending order by rank and in ascending order by key. Operation 412 uses range partitioning, with rank, key, and W as input parameters to the range partitioning function. The output of operation 412 is, for each of the M first-level partitions, N second-level partitions, which may also be referred to as micro-shards, 414.

The range partitioning function of operation 412, which is configured to perform range partitioning using the additional parameter W, produces micro-shards with roughly equal weights (data sizes). This is in contrast to traditional range partitioners, which would produce micro-shards that contain roughly equal numbers of data records irrespective of data record size. Because data records typically are not of equal size, traditional range partitioning techniques are often subject to data skew. However, the disclosed range partitioning function, using W as an input, avoids data skew problems.

Operation 416 when executed by at least one processor causes one or more computing devices to index the micro-shards 414 produced by operation 412. Operation 416 may perform the indexing of micro-shards 414 in parallel. The output of operation 416 is N indexed micro-shards for each of the M first-level partitions.

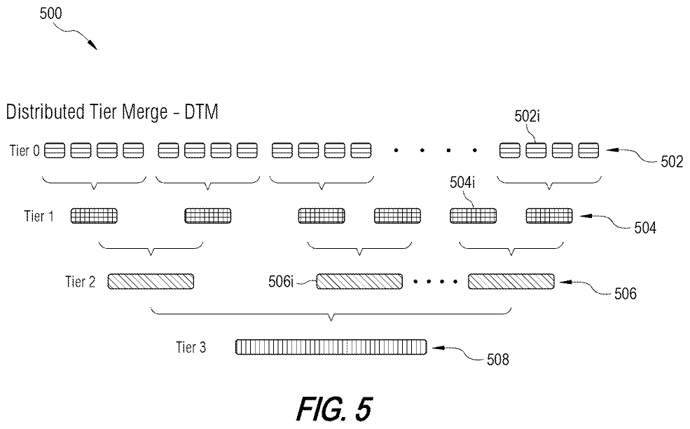

For each of the M first-level partitions, operation 418 merges the N indexed micro-shards to create M base indexes. An example implementation of operation 418 is shown in FIG. 5, described below.

Flow 400 makes the M base indexes available for use by, for example, the file system, e.g., distributed file system 150, or the downstream application, e.g., search engine 160 or application software system 170.

Example of Experimental Results

FIG. 4B is a plot of experimental results achieved by an embodiment of a portion of the computing system of FIG. 1. In particular, FIG. 4B shows a plot 450 of index size in Mb (megabytes) over index microshard number, sorted by static rank and UID. In plot 450, line graph 452 indicates the results achieved using prior approaches that did not include the improvements described herein. Line graph 454 indicates the results achieved using the technologies described herein. As can be seen from plot 450, line graph 452 indicates a significant amount of data skew resulted from the prior approach, while line graph 454 indicates that a significant amount of parallelism was achieved using the disclosed technologies. More specifically, line graph 452 shows data skew in that index micro-shards 0 to about 15 have index sizes of 1,000 Mb or more, while the remaining index micro-shards have index sizes below 1,000 Mb. In contrast, line graph 454 indicates that all of index micro-shards 0 to 100 have relatively uniform index sizes below 1,000 Mb.

Example Distributed Tier Merging Process

FIG. 5 is a flow diagram of a process that may be used to implement a portion of the computing system of FIG. 1. More specifically, flow 500 is an example of a process that may be used to, for each of M first-level partitions, merge the N indexed micro-shards produced by flow 400 to produce M base indexes.

Flow 500 distributes the merging operation across a number of host machines. Each merge operation may be assigned to a different host machine. Flow 500 also divides the merging step into a number of tiers, T. At each tier T, a number of merges is performed. The number of merges to be performed at each tier T is determined based on the number of index partitions, e.g., micro-shard indexes, that are to be merged in a single merge operation, P_{MT} at that tier, and the total number of micro-shard indexes, e.g., N. The number of tiers, T and the number of partitions per merge per tier, P_{MT} are parameterized such that the values of T and P_{MT} may be determined based on the type of merge operation to be performed (e.g., regular merge, flush or refresh, or force merge), the size of the input data, the number of micro-shards, N, and/or the configuration of, or requirements of, the execution environment. The values of T and P_{MT} for a particular merge process may be specified in a tier merge policy (TMP) and/or a concurrent merge scheduler (CMS) in LUCENE, for example.

In the example of FIG. 5, the number of tiers, T=4. At Tier 0, the number of partitions per merge, P_{MT}=4. That is, at Tier 0, four micro-shards 502i are merged to create one Tier 1 shard 504i. The number of groups of four micro-shards 502 depends on the total number of micro-shards, e.g., N.

At Tier 1, the number of partitions per merge, P_{MT}=2. That is, at Tier 1, two shards 504i are merged to create one Tier 2 shard 506i. The number of groups of two shards 504 at Tier 1 depends on the total number of groups of four micro-shards 502 at Tier 0.

At Tier 2, the number of partitions per merge, P_{MT}=3. That is, at Tier 2, three shards 504i are merged to create one final Tier 3 shard 508. The number of groups of three shards 506 at Tier 2 depends on the total number of groups of two shards 504 at Tier 1 and any implementation-specific rules. The final Tier 3 shard 508 is the base index.

An example of a rule for choosing the merge parameter values is a rule that ensures that there must be a particular number, e.g., 3, shards at the next-to-last tier, e.g., Tier 2. The P_{MT} values are set so that the shards can be merged into single index in one final tier (or else the tiering might never end). In the example of FIG. 5, [20, 4, 3] represents the P_{MT} values at Tiers [0, 1, 2] respectively, which results in a total of 20*4*3=240 shards at Tier 0. A P_{MT} of 20 shards per merge at Tier 0 produces 12 shards at Tier 1. Similarly, a P_{MT} of 4 shards per merge at Tier 1 produces 3 shards at Tier 2. With a P_{MT} of 3 shards per merge at Tier 2, only one merge is needed to produce the final index at Tier 3.

In this way, all merge operations at the same tier can be performed concurrently by assigning the individual merges to different host machines of a server cluster. The assignment of merge operations to host machines can be specified in the TMP, for example.

Example Hardware Architecture

According to one embodiment, the techniques described herein are implemented by at least one special-purpose computing device. The special-purpose computing device may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, mobile computing devices, wearable devices, networking devices or any other device that incorporates hard-wired and/or program logic to implement the techniques.

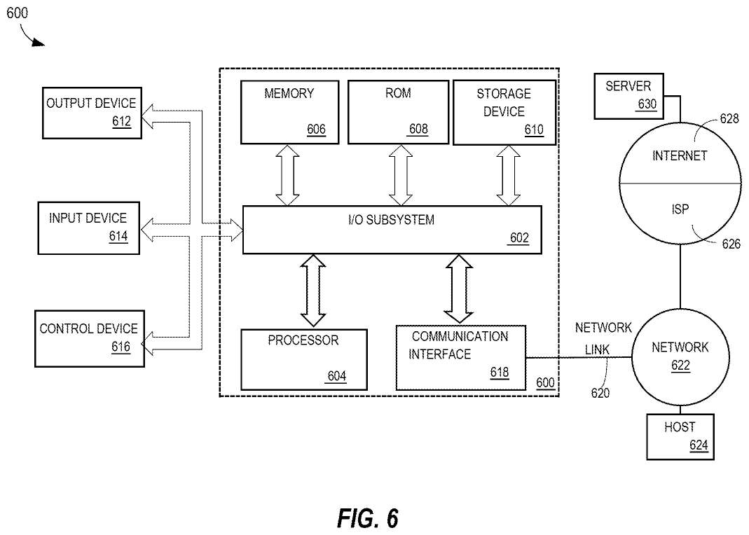

For example, FIG. 6 is a block diagram that illustrates a computer system 600 upon which an embodiment of the present invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory computer-readable storage media accessible to processor 604, render computer system 600 into a special-purpose machine that is customized to perform the operations specified in the instructions.

Computer system 600 and further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to an output device 612, such as a display, such as a liquid crystal display (LCD) or a touchscreen display, for displaying information to a computer user, or a speaker, a haptic device, or another form of output device. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, at least one ASIC or FPGA, firmware and/or program logic which in combination with the computer system causes or programs computer system 600 to be a special-purpose machine. According to one embodiment, the techniques herein are performed by computer system 600 in response to processor 604 executing at least one sequence of instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying at least one sequence of instruction to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated-services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through at least one network to other data devices. For example, network link 620 may provide a connection through local network 622 to a host computer 624 or to data equipment operated by an Internet Service Provider (ISP) 626. ISP 626 in turn provides data communication services through the world-wide packet data communication network commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 530 might transmit a requested code for an application program through Internet 628, ISP 626, local network 622 and communication interface 618. The received code may be executed by processor 604 as it is received, and/or stored in storage device 610, or other non-volatile storage for later execution.

### Additional Examples

Illustrative examples of the technologies disclosed herein are provided below. An embodiment of the technologies may include any of the examples or a combination of the described below.

In an example 1, a method includes, by a search index building system, determining a value of a number of partitions parameter, M, based on a downstream application; creating M first-level partitions of a set of data records using a key; calculating a boundary value N as a function of M; for each of the M first-level partitions, building an index for use by the downstream application by: building N second-level partitions using the key; indexing the N second-level partitions to produce N index micro-shards; determining a value of a number of tiers parameter, T, and, for each tier, a value of a partitions per merge parameter P; merging the N index micro-shards using T tiers and, for each tier, P_{MT} partitions per merge, distributed across a plurality of host machines; where M, N, T, and P_{MT} are each a positive integer.

An example 2 includes the subject matter of example 1, further including grouping data records of the set of data records according to the key to produce a single data record for each value of the key. An example 3 includes the subject matter of example 1 or example 2, further including calculating N as a co-prime of M. An example 4 includes the subject matter of any of examples 1-3, further including creating the N second-level partitions using hash partitioning and the key as an input to the hash partitioning. An example 5 includes the subject matter of any of examples 1-4, further including calculating a set of weight values, each as a function of a size of a data record of the set of data records, and creating the N second-level partitions using range partitioning and the set of weight values as an input to the range partitioning. An example 6 includes the subject matter of any of examples 1-5, further including sorting the set of data records in descending order by a rank and then in ascending order by the key. An example 7 includes the subject matter of any of examples 1-6, further including sorting the N second-level partitions in descending order by a rank and then in ascending order by the key. An example 8 includes the subject matter of any of examples 1-7, further including assigning each merge to a different host machine of the plurality of host machines. An example 9 includes the subject matter of any of examples 1-8, where the key includes an entity identifier and the set of data records includes entity profile records of a connections network system. An example 10 includes the subject matter of any of examples 1-9, where the downstream application includes a search engine capable of performing keyword searches on the set of data records.

In an example 11, an index building system includes: at least one processor; at least one computer memory operably coupled to the at least one processor; the at least one computer memory including instructions that when executed by the at least one processor are capable of causing the at least one processor to perform operations including: determining a value of a number of partitions parameter, M, based on a downstream application; creating M first-level partitions of a set of data records using a key; calculating a boundary value N as a function of M; for each of the M first-level partitions, building an index for use by the downstream application by: building N second-level partitions using the key; indexing the N second-level partitions; determining a value of a number of tiers parameter, T, and, for each tier, a value of a partitions per merge parameter P_{MT} merging the N second-level partitions using T tiers and, for each tier, P_{MT} partitions per merge, distributed across a plurality of host machines; where M, N, T, and P_{MT} are each a positive integer.

An example 12 includes the subject matter of example 11, where the instructions, when executed by the at least one processor, are capable of causing the at least one processor to perform operations further including grouping data records of the set of data records according to the key to produce a single data record for each value of the key. An example 13 includes the subject matter of example 11 or example 12, where the instructions, when executed by the at least one processor, are capable of causing the at least one processor to perform operations further including calculating N as a co-prime of M. An example 14 includes the subject matter of any of examples 11-13, where the instructions, when executed by the at least one processor, are capable of causing the at least one processor to perform operations further including creating the N second-level partitions using hash partitioning and the key as an input to the hash partitioning. An example 15 includes the subject matter of any of examples 11-14, where the instructions, when executed by the at least one processor, are capable of causing the at least one processor to perform operations further including calculating a set of weight values, each as a function of a size of a data record of the set of data records, and creating the N second-level partitions using range partitioning and the set of weight values as an input to the range partitioning. An example 16 includes the subject matter of any of examples 11-15, where the instructions, when executed by the at least one processor, are capable of causing the at least one processor to perform operations further including sorting the set of data records in descending order by a rank and then in ascending order by the key. An example 17 includes the subject matter of any of examples 11-16, where the instructions, when executed by the at least one processor, are capable of causing the at least one processor to perform operations further including sorting the N second-level partitions in descending order by a rank and then in ascending order by the key. An example 18 includes the subject matter of any of examples 11-17, where the instructions, when executed by the at least one processor, are capable of causing the at least one processor to perform operations further including assigning each merge to a different host machine of the plurality of host machines. An example 19 includes the subject matter of any of examples 11-18, where the key includes an entity identifier and the set of data records includes entity profile records of a connections network system. An example 20 includes the subject matter of any of examples 11-19, where the downstream application includes a search engine capable of performing keyword searches on the set of data records.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

Terms such as “computer-generated” and “computer-selected” as may be used herein may refer to a result of an execution of one or more computer program instructions by one or more processors of, for example, a server computer, a network of server computers, a client computer, or a combination of a client computer and a server computer.

As used here, “online” may refer to a particular characteristic of a connections network-based system. For example, many connections network-based systems are accessible to users via a connection to a public network, such as the Internet. However, certain operations may be performed while an “online” system is in an offline state. As such, reference to a system as an “online” system does not imply that such a system is always online or that the system needs to be online in order for the disclosed technologies to be operable.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various features of the disclosure have been described using process steps. The functionality/processing of a given process step potentially could be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features mentioned or evident from the text or drawings. These different combinations constitute various alternative aspects of the embodiments.

What is claimed is:

1. A method comprising, by a search index building system:
determining a value of a number of partitions parameter, M, based on a downstream application;
creating M first-level partitions of a set of data records using a key;
calculating a boundary value N as a function of M;
for each of the M first-level partitions, building an index for use by the downstream application by
(i) building N second-level partitions using the key;
(ii) indexing the N second-level partitions to produce N index micro-shards;
(iii) determining a value of a number of tiers parameter, T, and, for each tier, a value of a partitions per merge parameter P_{MT},
(iv) merging the N index micro-shards using T tiers and, for each tier, P_{MT} partitions per merge, distributed across a plurality of host machines;
wherein M, N, T, and P_{MT} are each a positive integer.

2. The method of claim 1, further comprising grouping data records of the set of data records according to the key to produce a single data record for each value of the key.

3. The method of claim 1, further comprising calculating N as a co-prime of M.

4. The method of claim 1, further comprising creating the N second-level partitions using hash partitioning and the key as an input to the hash partitioning.

5. The method of claim 1, further comprising calculating a set of weight values, each as a function of a size of a data record of the set of data records, and creating the N second-level partitions using range partitioning and the set of weight values as an input to the range partitioning.

6. The method of claim 1, further comprising sorting the set of data records in descending order by a rank and then in ascending order by the key.

7. The method of claim 1, further comprising sorting the N second-level partitions in descending order by a rank and then in ascending order by the key.

8. The method of claim 1, further comprising assigning each merge to a different host machine of the plurality of host machines.

9. The method of claim 1, wherein the key comprises an entity identifier and the set of data records comprises entity profile records of a connections network system.

10. The method of claim 1, wherein the downstream application comprises a search engine capable of performing keyword searches on the set of data records.

11. An index building system, comprising:
at least one processor;
at least one computer memory operably coupled to the at least one processor;
the at least one computer memory comprising instructions that when executed by the at least one processor are capable of causing the at least one processor to perform operations comprising:
calculating a boundary value N as a function of a parameter M;
for each of M first-level partitions of a set of data records, building an index by
(i) building N second-level partitions using a key;
(ii) indexing the N second-level partitions;
(iii) determining a value of a number of tiers parameter, T, and, for each tier, a value of a partitions per merge parameter P_{MT},
(iv) merging the N second-level partitions using T tiers and, for each tier, P_{MT} partitions per merge, distributed across a plurality of host machines;
wherein M, N, T, and P_{MT} are each a positive integer, a value of M is determined based on a downstream application, and the M first-level partitions of are created using the key.

12. The system of claim 11, wherein the instructions, when executed by the at least one processor, are capable of causing the at least one processor to perform operations further comprising grouping data records of the set of data records according to the key to produce a single data record for each value of the key.

13. The system of claim 11, wherein the instructions, when executed by the at least one processor, are capable of causing the at least one processor to perform operations further comprising calculating N as a co-prime of M.

14. The system of claim 11, wherein the instructions, when executed by the at least one processor, are capable of causing the at least one processor to perform operations further comprising creating the N second-level partitions using hash partitioning and the key as an input to the hash partitioning.

15. The system of claim 11, wherein the instructions, when executed by the at least one processor, are capable of causing the at least one processor to perform operations further comprising calculating a set of weight values, each as a function of a size of a data record of the set of data records, and creating the N second-level partitions using range partitioning and the set of weight values as an input to the range partitioning.

16. The system of claim 11, wherein the instructions, when executed by the at least one processor, are capable of causing the at least one processor to perform operations further comprising sorting the set of data records in descending order by a rank and then in ascending order by the key.

17. The system of claim 11, wherein the instructions, when executed by the at least one processor, are capable of causing the at least one processor to perform operations further comprising sorting the N second-level partitions in descending order by a rank and then in ascending order by the key.

18. The system of claim 11, wherein the instructions, when executed by the at least one processor, are capable of causing the at least one processor to perform operations further comprising assigning each merge to a different host machine of the plurality of host machines.

19. The system of claim 11, wherein the key comprises an entity identifier and the set of data records comprises entity profile records of a connections network system.

20. The system of claim 11, wherein the downstream application comprises a search engine capable of performing keyword searches on the set of data records.
